(19) United States
(12) Patent Application Publication
(10) Pub. No.: US 2010/0238546 A1
(43) Pub. Date: Sep. 23, 2010

(54) THREE-DIMENSIONAL DISPLAY APPARATUS

(75) Inventors: Wei-Liang Hsu, Taipei City (TW); Chao-Hsu Tsai, Hsinchu City (TW); Shu-Chuan Cheng, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/725,464

(22) Filed: Mar. 17, 2010

(30) Foreign Application Priority Data
Mar. 17, 2009 (TW) 98108622

(51) Int. Cl. G02B 27/26

(52) U.S. Cl. 359/465

(57) ABSTRACT

A three-dimensional display apparatus including a pair of polarized glasses having first and second circularly polarized eyeglass with different polarization directions, a display panel displaying a linearly polarized image, a third quarter-wave plate and a patterned half-wave plate is provided. The first circularly polarized eyeglass has a first quarter-wave plate and a first half-wave plate. The second circularly polarized eyeglass has a second quarter-wave plate. The angle between polarization direction of the linearly polarized image and optical axis of the third quarter-wave plate is 45 degrees. The angle between optical axis of the first quarter-wave plate and optical axis of the third quarter-wave plate is 90 degrees. The angle between optical axis of the first half-wave plate and optical axis of the patterned half-wave plate is 90 degrees. The angle between optical axis of the second quarter-wave plate and optical axis of the third quarter-wave plate is 55-125 degrees.

### CROSS-REFERENCE TO RELATED APPLICATION

This application claims the priority benefit of Taiwan application serial no. 98108622, filed on Mar. 17, 2009. The entirety of the above-mentioned patent application is hereby incorporated by reference herein and made a part of specification.

### BACKGROUND OF THE DISCLOSURE

1. Technical Field

The present disclosure relates to a three-dimensional display apparatus.

2. Description of Related Art

With development of technology, people are pursuing higher and higher quality in their material and sprit lives. For example, at the era in which the technology improvement is never ending, people wish to fulfill their creative imagination by using a display apparatus to have a simulated feeling as if it was really happening. Therefore, enabling the display apparatus to display three-dimensional pictures or images has become one of the most important goals to achieve in the current display technology.

In terms of the method of use, the three-dimensional display technology can generally be classified into a stereoscopic type in which observers need to wear dedicated glasses to observe 3D images, and an auto-stereoscopic type in which observers can directly observe by naked eye. The stereoscopic type display can be realized by using anaglyph glasses, a pair of polarized glasses or shutter glasses, operating in coordination with suitable displays and image formats. The principle of stereoscopic type display is that a display is used to present the left and right eye images on the same screen, while glasses with filters utilizing color, polarization, or time so that the left and right eyes observe the left and right images, respectively.

FIG. 1 illustrates a display mechanism of a three-dimensional display used in conjunction with a pair of polarized glasses. Referring to FIG. 1, the three-dimensional display apparatus 100 is adapted to be observed by an observer wearing the pair of polarized glasses 110. The pair of polarized glasses 110 includes two linearly polarized eyeglasses with polarization directions of P1 and P2, respectively. The three-dimensional display apparatus 100 includes a display panel 120 and a polarizer 130. The polarizer 130 is disposed between the display panel 120 and the pair of polarized glasses 110. As shown in FIG. 1, the display panel 120 has a plurality of pixels arranged into an array, with odd columns (or rows) of pixels and even columns (or rows) of pixels presenting the right eye image R and the left eye image L, respectively. In addition, the polarizer 130 has regions with polarization directions of P1 and P2, respectively. The region with the P1 polarization and the region with the P2 polarization correspond to the right eye image R presented by the odd columns (or rows) of pixels and the left eye image L presented by the even columns (or rows) of pixels, respectively, such that the outputted right eye image R has a P1 polarization direction and the outputted left eye image L has a P2 polarization direction. The observer can observe the right eye image R with the P1 polarization direction through the linearly polarized eyeglass with the P1 polarization direction and can observe the left eye image L with the P2 polarization direction through the linearly polarized eyeglass with the P2 polarization direction. In other words, when the observer wearing the pair of polarized glasses 110 observes the image of the three-dimensional display apparatus 100, the left and right eyes can observe the left eye image L with the P2 polarization direction and the right eye image R with the P1 polarization direction, respectively, through the linearly polarized eyeglasses with different polarization thus forming the stereo vision. U.S. Pat. No. 6,498,679 proposes a laser scanning method to fabricate microretarder film, which combines with polarizer to function as the patterned polarizer 130 in FIG. 1. Although the laser scanning method has characteristics of environment friendly, one-step process, and high production flexibility. However, the three-dimensional display apparatus using the microretarder fabricated by laser scanning would become linear-polarizer type. When the user tilts his/her head, a problem of cross-talking becomes serious along with the increase of the titled angle, and thus the three-dimension vision is greatly influenced. One way of solving the above-mentioned problem is adding a quarter-wave plate, so that the three-dimensional display apparatus becomes circular polarization type. However, due to the characteristics of microretarder fabricated by laser scanning, the three-dimensional display apparatus could not obtain excellent performance by merely adding a quarter-wave plate with 45 degrees because of cross-talking and color shift. Some specifically structure design is required.

### SUMMARY OF THE DISCLOSURE

Accordingly, the present disclosure is directed to a stereoscopic display apparatus using microretarder fabricated by laser scanning which is circular polarization type.

The present disclosure provides a three-dimensional display apparatus which includes a pair of polarized glasses, a display panel, a third quarter-wave plate and a patterned half-wave plate. The pair of polarized glasses includes a first circularly polarized eyeglass and a second circularly polarized eyeglass with different polarization. The first circularly polarized eyeglass includes a first quarter-wave plate and a first half-wave plate. The second circularly polarized eyeglass includes a second quarter-wave plate. Each of the first circularly polarized eyeglass and the second circularly polarized eyeglass has a linear polarizer. The display panel has a plurality of pixels arranged into an array and is adapted to display a linearly polarized image. The third quarter-wave plate is disposed between the display panel and the pair of polarized glasses, and an included angle formed between a polarization direction of the linearly polarized image and an optical axis of the third quarter-wave plate is substantially 45 degrees. In addition, the patterned half-wave plate is disposed between the display panel and the pair of polarized glasses, and the third quarter-wave plate is disposed between the display panel and the patterned half-wave plate. It should be noted that an included angle formed between an optical axis of the first quarter-wave plate and the optical axis of the third quarter-wave plate is substantially 90 degrees, an included angle formed between an optical axis of the first half-wave plate and an optical axis of the patterned half-wave plate is substantially 90 degrees, and an included angle formed between an optical axis of the second quarter-wave plate and the optical axis of the third quarter-wave plate is substantially between 55 degrees and 125 degrees.

In view of the foregoing, the three-dimensional display apparatus of the present disclosure employs a patterned half-wave plate having different regions with different phase-retardation which enable the three-dimensional display apparatus to produce left and right eye images with different polarization directions. Also, the three-dimensional display apparatus employs a quarter-wave plate to convert a linearly polarized image into a circularly polarized image, and is used in conjunction with a combination of a quarter-wave plate and a half-wave plate with appropriate optical axis included angles. Therefore, the three-dimensional display apparatus of the present disclosure can compensate for the color shift of the image outputted by the display panel. Thus, the three-dimensional display apparatus of the present disclosure can allow the observer to observe the three-dimensional image through the pair of polarized glasses having circularly polarized eyeglasses with different polarization, and compensate for the color shift and improve the chromatic aberration by appropriately configuring the polarization included angle of the circularly polarized eyeglass. Moreover, the present disclosure enables large-sized three-dimensional display apparatuses to be fabricated.

In order to make the aforementioned and other features of the present disclosure more comprehensible, embodiments accompanied with figures are described in detail below.

### BRIEF DESCRIPTION OF THE DRAWINGS

FIG. 1 illustrates a display mechanism of a three-dimensional display used in conjunction with a pair of polarized glasses.

FIG. 2A illustrates a three-dimensional display apparatus according to a first embodiment of the present disclosure.

FIG. 2B illustrates a laser process for the patterned half-wave plate.

FIGS. 3 and 4 illustrate respective displaying states of the image displayed by the display panel that travels through different regions of the patterned half-wave plate.

FIG. 5 illustrates a three-dimensional display apparatus according to a second embodiment of the present disclosure.

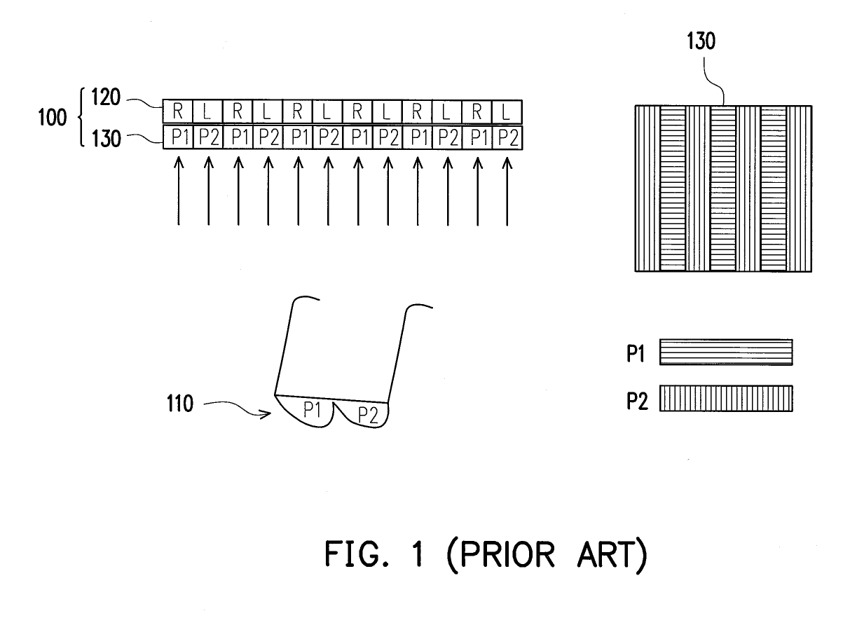

### DESCRIPTION OF THE EMBODIMENTS

### First Embodiment

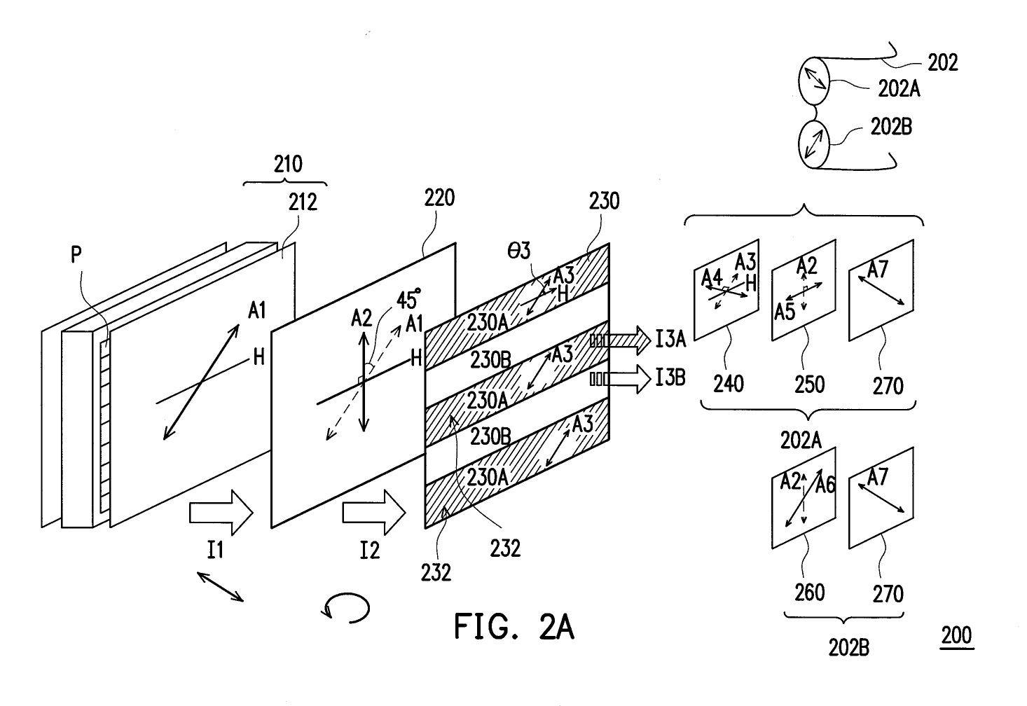

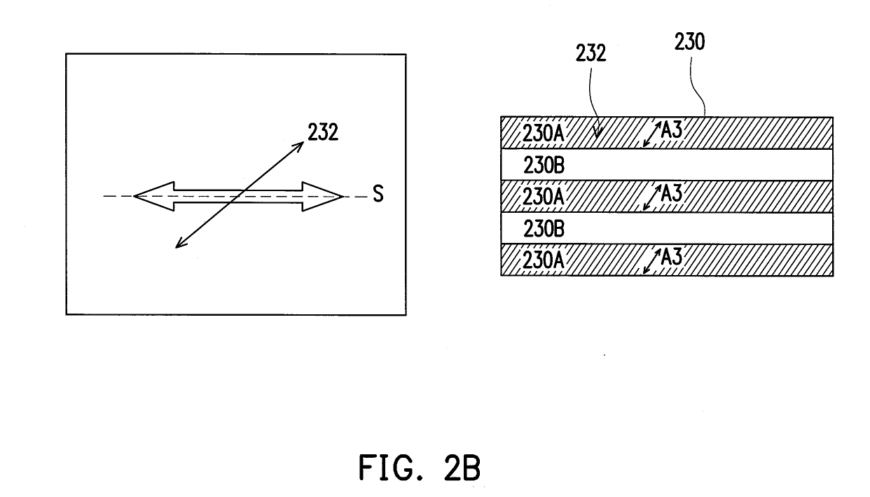

FIG. 2A illustrates a three-dimensional display apparatus according to a first embodiment of the present disclosure. Referring to FIG. 2A, the three-dimensional display apparatus 200 is adapted to be observed by an observer wearing a pair of polarized glasses 202. The pair of polarized glasses 202 has a first circularly polarized eyeglass 202A and a second circularly polarized eyeglass 202B that have different polarization directions. The structures of the first circularly polarized eyeglass 202A and the second circularly polarized eyeglass 202B are shown in FIG. 2A. The first circularly polarized eyeglass 202A may be considered as a combination of a first quarter-wave plate 250, a half-wave plate 240, and a linear polarizer 270. The second circularly polarized eyeglass 202B may be considered as a combination of a second quarter-wave plate 260 and a linear polarizer 270. In addition, the three-dimensional display apparatus 200 further includes a display panel 210, a third quarter-wave plate 220, and a patterned half-wave plate 230. In the present embodiment, the patterned half-wave plate 230 is disposed between the display panel 210 and the pair of polarized glasses 202, and the third quarter-wave plate 220 is disposed between the display panel 210 and the patterned half-wave plate 230. The display panel 210 further includes a panel polarizer 212 for polarizing an image outputted by the display panel 210. Examples of the display panel 210 may include a liquid crystal display panel, an organic electroluminescent display panel, a plasma display panel, or an electrowetting display panel. It is to be noted that these examples are only illustrative and the display panel 210 could be another suitable display panel.

As shown in FIG. 2A, the display panel 210 has a plurality of pixels P arranged into an array, and the panel polarizer 212 is disposed between the pixels P and the pair of polarized glasses 202. The panel polarizer 212 has an absorption axis A1 such that the image displayed by the display panel 210 is transferred by the panel polarizer 212 to a linearly polarized image I1 with a polarization direction perpendicular to the absorption axis A1. The linearly polarized image I1 is then transferred by the third quarter-wave plate 220 to a circularly polarized image I2. Specifically, with respect to a horizontal direction H of the three-dimensional display apparatus, an optical axis A2 of the third quarter-wave plate 220 is, for example, perpendicular to the horizontal direction H and a substantial 45 degrees included angle is formed between the absorption axis A1 of the panel polarizer 212 and the optical axis A2 of the third quarter-wave plate 220 in the present embodiment. In other words, a substantial 45 degrees included angle is formed either between the polarization direction of the linearly polarized image I1 and the optical axis A2 of the third quarter-wave plate 220, or between the polarization direction of the linearly polarized image I1 and the horizontal direction H. As such, the linearly polarized image I1 is transferred by the third quarter-wave plate 220 to a right circularly polarized image I2 as shown in FIG. 2A.

In addition, the patterned half-wave plate 230 has two regions with different phase-retardation. One region has a phase-retardation of substantial λ/2 (λ represents the wavelength), for example, a λ/2 phase-retardation region 230A shown in the figure, while the other region has a phase-retardation of substantial zero, for example, a no-phase-retardation region 230B shown in the figure. Specifically, the optical properties of light after traveling through the patterned half-wave plate 230 are dependent upon a stretch axis 232 such that the direction of an optical axis A3 of the patterned half-wave plate is defined as the direction of the stretch axis 232 of the λ/2 phase-retardation region 230A. On the other hand, the no-phase-retardation region 230B does not affect the polarization of the light traveling therethrough. Therefore, the no-phase-retardation region 230B provides a phase-retardation substantially approaching zero. Due to various factors in the heating process (e.g., laser) of the patterned half-wave plate 230, the included angle θ3 between the optical axis A3 of the patterned half-wave plate 230 (within the λ/2 phase-retardation region 230A) and the horizontal direction H satisfies the following condition: 45°≦θ3≦135°.

It should be noted that the regions with different phase-retardation in the patterned half-wave plate are, for example, arranged alternately and each region is positioned corresponding to the pixels P of the display panel 210. For example, the patterned half-wave plate 230 has a plurality of strip patterns corresponding to either even rows of pixels P or odd rows of pixels P, respectively. It should be understood, however, that the strip patterns can also correspond to even columns or odd columns of pixels P, respectively, and the present disclosure does not limit the pattern configuration of the patterned half-wave plate 230 to any particular embodiment described herein. Since the patterned half-wave plate 230 has the regions with different phase-retardation, an image I3A which passed through the regions with a phase-retardation of substantial λ/2 and an image I3B which passed through the regions with a phase-retardation of substantial zero can be separated.

More specifically, FIG. 2B illustrates a heating process (e.g., laser) for the patterned half-wave plate. Referring to FIG. 2B, in the fabrication of the patterned half-wave plate 230, a uniform half-wave plate (not shown) is first provided, for example. The half-wave plate (not shown) is usually formed by a phase-retardation film, optical properties of which can be adjusted by adjusting the arrangement of molecules in the phase-retardation film. For example, the overall molecules of the phase-retardation film are stretched in a same direction such that the half-wave plate (not shown) has an overall stretch axis 232 entirely thereof Next, a laser process is used to perform a patterning process. During this process, partial regions of the half-wave plate are radiated by the laser such that the molecules of the radiated regions become disorderly arranged upon absorbing the laser energy. In general, although the no-phase-retardation region 230B of the patterned half-wave plate 230 can exhibit a phase-retardation approaching zero by performing the process as discussed above, in practice, the no-phase-retardation regions 230B still has tiny phase-retardation due to certain process factors, which tiny phase-retardation can easily cause a crosstalk and chromatic aberration of the three-dimensional image.

It should be noted that the constitutional components of the pair of polarized glasses 202 have optical axes with appropriate included angles such that, when appropriately assembled, they can effectively compensate for the color shift produced at the time the image travels through the third quarter-wave plate 220 and the patterned half-wave plate 230, thereby eliminating the chromatic aberration. Specifically, as shown in FIG. 2A, the linear polarizer 270 of the first circularly polarized eyeglass 202a and the second circularly polarized eyeglass 202B have an absorption axis A7 perpendicular to the absorption axis A1 of the panel polarizer 212. In particular, in the components of the first circularly polarized eyeglass 202A, an optical axis A4 of the first half-wave plate 240 and an optical axis A3 of the patterned half-wave plate 230 form a substantial 90 degrees included angle therebetween, and an optical axis A5 of the first quarter-wave plate 250 and the optical axis A2 of the third quarter-wave plate 220 form a substantial 90 degrees included angle therebetween. Therefore, the color shift deceived by an observer can be compensated by using the first half-wave plate 240 and the first quarter-wave plate 250 of the first circularly polarized eyeglass 202A thus eliminating the chromatic aberration.

In addition, as shown in FIG. 2A, in the components of the second circularly polarized eyeglass 202B, an optical axis A6 of the second quarter-wave plate 260 and the optical axis A2 of the third quarter-wave plate 220 form an included angle of substantial between 55 degrees and 125 degrees. By appropriately controlling the included angle between the optical axis A6 of the second quarter-wave plate 260 and the optical axis A2 of the third quarter-wave plate 220, the tiny phase-retardation produced at the time the image travels through the no-phase-retardation region 230B of the patterned half-wave plate 230 can be eliminated. As such, in the present disclosure, the no-phase-retardation region 230B is allowed to have a tiny phase-retardation due to process factors or other factors, and the color shift of the image can be compensated by adjusting the direction of the optical axis of the second quarter-wave plate 260 thus eliminating the chromatic aberration.

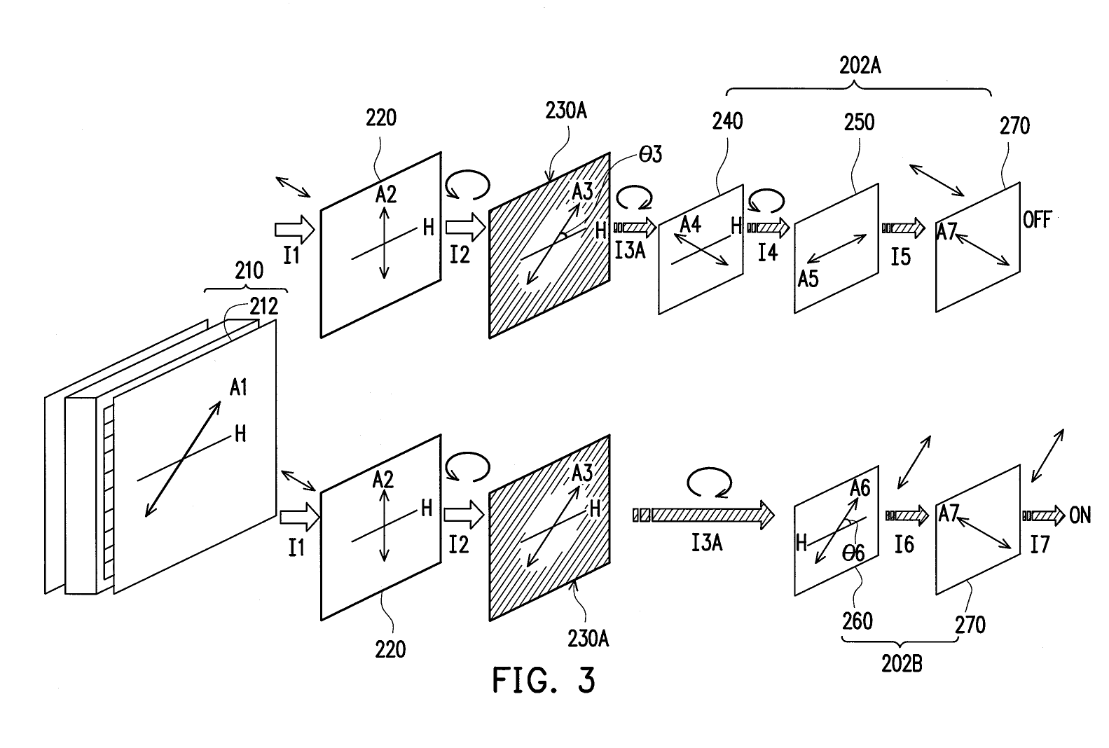

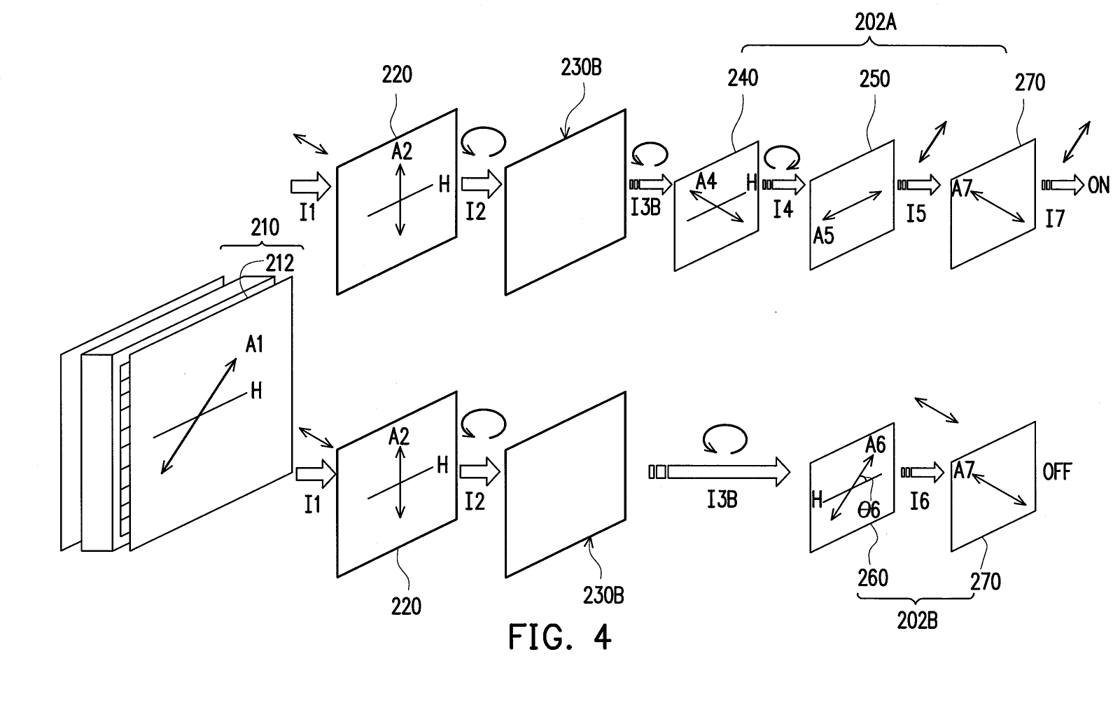

In order to more fully describe the principle of the present disclosure, a displaying mechanism of the three-dimensional display apparatus 200 is explained below. FIGS. 3 and 4 illustrate respective displaying states of the image displayed by the display panel that travels through different regions on the patterned half-wave plate, with FIG. 3 illustrating the displaying state of the image traveling through the λ/2 phase-retardation region 230A and FIG. 4 illustrating the displaying state of the image traveling through the no-phase-retardation region 230B.

Referring first to an upper portion of FIG. 3, it illustrates the polarization state of the image traveling through the λ/2 phase-retardation region 230A of the half-wave plate and the first circularly polarized eyeglass 202A. As shown in the upper portion of FIG. 3, a λ/4 phase-retardation provided by the third quarter-wave plate 220 can cause the linearly polarized image I1 with the polarization direction perpendicular to the absorption axis A1 to be transferred to a circularly polarized image I2 (the right circularly polarized image shown in the figure) before entering the patterned half-wave plate 230. Next, the circularly polarized image I2 enters the λ/2 phase-retardation region 230A of the patterned half-wave plate 230 and the λ/2 phase-retardation provided by the λ/2 phase-retardation region 230A can cause the circularly polarized image I2 to be transferred to a circularly polarized image I3A with an reversed circular polarization direction which in turn enters the first circularly polarized eyeglass 202A of the pair of polarized glasses 202 worn by the observer. As shown in the figure, the right circularly polarized image I2 traveling through the λ/2 phase-retardation region 230A of the patterned half-wave plate 230 is transferred to a left circularly polarized image I3A.

Referring to the upper portion of FIG. 3, the λ/2 phase-retardation provided by the first half-wave plate 240 can cause the circularly polarized image I3A to be transferred to a circularly polarized image I4 with a reversed circular polarization direction which in turn enters the first quarter-wave plate 250. In other words, the left circularly polarized image I3A traveling through the first half-wave plate 240 is transferred to the right circularly polarized image I4 again. Next, the right circularly polarized image I4 is transferred to a linearly polarized image I5 by a λ/4 phase-retardation provided by the first quarter-wave plate 250 before entering the linear polarizer 270. As shown in FIG. 3, since the polarization direction of the linearly polarized image I5 before entering the linear polarizer 270 is parallel to an absorption axis A7 of the linear polarizer 270, the linearly polarized image I5 cannot travel through the linear polarizer 270 and thus cannot be observed by the observer. In other words, in the current state, the observer cannot observe the image through the first circularly polarized eyeglass 202A.

Next, referring to a lower portion of FIG. 3, it illustrates the polarization state of the image displayed by the same pixels P and observed by the observer through the second circularly polarized eyeglass 202B at the same time and the image likewise travels through the λ/2 phase-retardation region 230A of the patterned half-wave plate 230. As shown in the lower portion of FIG. 3, the polarization state of the image before entering the second circularly polarized eyeglass 202B are similar to those shown in the upper portion of FIG. 3. The linearly polarized image I1 with the initial polarization direction perpendicular to the absorption axis A1 is transferred to the left circularly polarized image I3A after traveling through the third quarter-wave plate 220 and the patterned half-wave plate 230 as shown in the figure. The left circularly polarized image I3A is then transferred to a linearly polarized image I6 with a polarization direction perpendicular to the absorption axis A7 of the linear polarizer 270 after traveling through the second quarter-wave plate 260 which provides a λ/4 phase-retardation. As a result, the observer can observe an image I7 through the second circularly polarized eyeglass 202B. As such, during the operation as shown in FIG. 3, the single eye image observed by the observer can be separated using the combination of the optical film components as discussed above.

Next, referring to an upper portion of FIG. 4, it illustrates the polarization state of the image traveling through the no-phase-retardation region 230B of the half-wave plate and the first circularly polarized eyeglass 202A. As shown in the upper portion of FIG. 4, the λ/4 phase-retardation provided by the third quarter-wave plate 220 can cause the linearly polarized image I1 with the polarization direction perpendicular to the absorption axis A1 to be transferred to a circularly polarized image I2 (the right circularly polarized image as shown in the figure) before entering the patterned half-wave plate 230. Next, the circularly polarized image I2 travels through the no-phase-retardation region 230B of the patterned half-wave plate 230 and maintains its original polarization direction. Then, the λ/2 phase-retardation provided by the first half-wave plate 240 can cause the circularly polarized image I3B to be transferred to a circularly polarized image I4 with a reversed circular polarization direction, which in turn enters the first quarter-wave plate 250. In other words, the right circularly polarized image I3B is transferred to a left circularly polarized image I4 after traveling through the first half-wave plate 240. Next, the λ/4 phase-retardation provided by the first quarter-wave plate 250 causes the left circularly polarized image I4 to be transferred to a linearly polarized image I5 with a polarization direction perpendicular to the absorption axis A7 of the linear polarizer 270 before the left circularly polarized image I4 enters the linear polarizer 270. As such, the observer can observe the image I7 through the first circularly polarized eyeglass 202A.

Subsequently, referring to a lower portion of FIG. 4, it illustrates the polarization state of the image displayed by the same pixels P and observed by the observer through the second circularly polarized eyeglass 202B at the same time and the image likewise travels through the no-phase-retardation region 230B of the patterned half-wave plate 230. As shown in the lower portion of FIG. 4, the polarization state of the image before entering the second circularly polarized eyeglass 202B are similar to those shown in the upper portion of FIG. 4. The linearly polarized image I1 with the initial polarization direction perpendicular to the absorption axis A1 is transferred to the right circularly polarized image I3B after traveling through the third quarter-wave plate 220 and the no-phase-retardation region 230B of the patterned half-wave plate 230 as shown in the figure. The right circularly polarized image I3B is then transferred to a linearly polarized image I6 after traveling through the second quarter-wave plate 260 which provides a λ/4 phase-retardation, as shown in FIG. 4. Since the polarization direction of the linearly polarized image I6 before entering the linear polarizer 270 is parallel to the absorption axis A7 of the linear polarizer 270, the observer cannot observe an image through the second circularly polarized eyeglass 202B in this state. Likewise, during the operation shown in FIG. 4, another single eye image observed by the observer can be separated using the combination of the optical film components as discussed above.

Therefore, by repeating the displaying steps as illustrated in FIG. 3 and FIG. 4, the three-dimensional display apparatus 200 of the present embodiment enables the observer to observe a three-dimensional image formed by overlapping the images traveling through the λ/2 phase-retardation region 230A and the no-phase-retardation region 230B of the patterned half-wave plate 230. It is to be noted that, in addition to the elimination of color shift, the circularly polarized image with circular polarization of the present embodiment has components approximately evenly distributed along the polarization direction when compared with the prior linearly polarized image with linear polarization, such that the observer wearing the polarized glass 202 can observe more even three-dimensional images when observing from different view included angles. Therefore, the provision of the quarter-wave plates of the present embodiment can facilitate increasing the view included angle of the three-dimensional display apparatus 200. Besides, by appropriately configuring the optical axis included angles of the first half-wave plate 240, the first quarter-wave plate 250 and the second quarter-wave plate 260, the polarized glass 202 can compensate for the color shift of the image before entering the polarized glass 202 and correct the chromatic aberration of the image before entering the observer's eyes, thereby improving the quality of the image displayed by the display panel 210.

While the first half-wave plate 240 is positioned between the first quarter-wave plate 250 and the display panel 210 in the present embodiment, it should be noted that the position of the first quarter-wave plate 250 and the first half-wave plate 240 can be interchanged such that the first quarter-wave plate 250 is positioned between the first half-wave plate 240 and the display panel 210. Therefore, the present disclosure imposes no limitation on the positional relationship between the first quarter-wave plate 250 and the first half-wave plate 240. In addition, in practice, an included angle θ6 formed between the optical axis A6 of the second quarter-wave plate 260 and the horizontal direction H is selected such that 0°≦θ6≦±35°. For example, the included angle θ6 is 25° with respect to the horizontal direction H.

It should be noted that the correspondence between the patterns of the patterned half-wave plate 230 and the pixels P of the display panel 210 may be designed based on actual requirements, or appropriate sequence control is used to adjust the frequency of updating left and right eye images such that the three-dimensional image observed by the observer can maintain its original resolution and achieve a good optical quality. It should also be noted that the present disclosure imposes no limitation on the shape, size and arrangement of the patterns of the patterned half-wave plate 230 and the sequence control.

### Second Embodiment

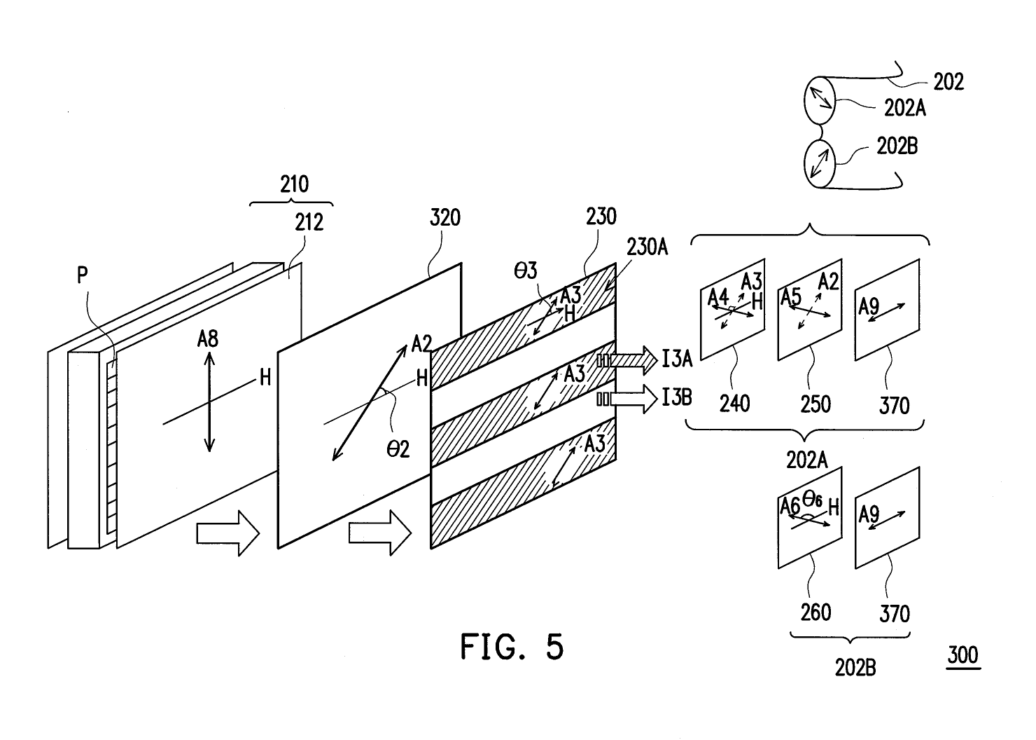

FIG. 5 illustrates a three-dimensional display apparatus according to a second embodiment of the present disclosure. Referring to FIG. 5, the three-dimensional display apparatus 300 is similar to the three-dimensional display apparatus 200 of the first embodiment except that the polarization direction of the linearly polarized image outputted by the display panel 210 of the three-dimensional display apparatus 300 is substantially perpendicular to the horizontal direction H of the three-dimensional display apparatus 300. It should be noted that the included angle θ2 formed between the optical axis A2 of the third quarter-wave plate 320 and the horizontal direction H may be 45 degrees or 135 degrees, and in the present embodiment is, for example, 45 degrees. The included angle θ3 formed between the optical axis A3 of the λ/2 phase-retardation region 230A of the half-wave plate and the horizontal direction H is, for example, any included angle between 45 degrees and 135 degrees. Besides, the direction of an absorption axis A9 of the linear polarizer 370 is substantially perpendicular to an absorption axis A8 of the panel polarizer 212.

In addition, the first quarter-wave plate 250, the first half-wave plate 240 and the second quarter-wave plate 260 likewise satisfy the conditions that: the optical axis A4 of the first half-wave plate 240 is substantially perpendicular to the optical axis A3 of the patterned half-wave plate 230, the optical axis AS of the first quarter-wave plate 250 is substantially perpendicular to the optical axis A2 of the third quarter-wave plate 320, and the included angle formed between the optical axis A6 of the second quarter-wave plate 260 and the optical axis A2 of the third quarter-wave plate 320 is substantially between 55 degrees and 125 degrees. In other words, the included angle θ6 formed between the optical axis A6 of the second quarter-wave plate 260 and the horizontal direction H is substantially between 100 degrees and 170 degrees. As a result, the three-dimensional display apparatus 300 of the present embodiment can likewise compensate for color shift of the image thus improving the image quality.

In the three-dimensional display apparatus 300, the third quarter-wave plate 320 is disposed between the patterned half-wave plate 230 and the display panel 210. Besides, the polarization direction A8 of the linearly polarized image outputted by the display panel 210 may also be parallel to the horizontal direction H of the three-dimensional display apparatus 300, and the optical axis included angle of the various optical films of the three-dimensional display apparatus 300 can be designed based on the principles described above to eliminate the chromatic aberration. It is also to be noted that the present disclosure imposes no limitation on the polarization direction of the image outputted by the display panel 210.

In summary, the three-dimensional display apparatus of the present embodiment has at least one of the following features:
1. When used in conjunction with an appropriate pair of polarized glasses, the three-dimensional display apparatus of the present disclosure can compensate for color shift of the image outputted by the display panel after the image travels through the optical films By appropriately configuring the polarization included angle of the circularly polarized eyeglass of the pair of polarized glasses, the color shift of the image can be compensated thus improving the chromatic aberration problem.
2. The three-dimensional display apparatus of the present disclosure employs a patterned half-wave plate having different regions with different phase-retardation which enable the three-dimensional display apparatus to produce left and right eye images with different polarization directions. Also, the three-dimensional display apparatus employs a quarter-wave plate to transfer a linearly polarized image to a circularly polarized image, which can increase the view included angle of the three-dimensional display apparatus.
3. The three-dimensional display apparatus of the present disclosure eliminates the chromatic aberration problem by appropriately configuring the optical axis included angles of the quarter-wave plate and half-wave plate of the polarized glass. Therefore, the present disclosure permits the no-phase-retardation region to have tiny phase-retardation due to process factors or other factors, thereby enabling the large-size of the three-dimensional display apparatus as well as achieving improved three-dimensional image quality.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A three-dimensional display apparatus at least comprising:
a pair of polarized glasses comprising a first circularly polarized eyeglass and a second circularly polarized eyeglass with different polarization directions, the first circularly polarized eyeglass comprising a first quarter-wave plate and a first half-wave plate, the second circularly polarized eyeglass comprising a second quarter-wave plate, and each of the first circularly polarized eyeglass and the second circularly polarized eyeglass has a linear polarizer;
a display panel having a plurality of pixels arranged into an array, the display panel adapted to display a linearly polarized image;
a third quarter-wave plate disposed between the display panel and the pair of polarized glasses, an included angle between a polarization direction of the linearly polarized image and an optical axis of the third quarter-wave plate being substantially 45 degrees; and
a patterned half-wave plate disposed between the display panel and the pair of polarized glasses, the third quarter-wave plate disposed between the display panel and the patterned half-wave plate;
wherein a included angle between an optical axis of the first quarter-wave plate and the optical axis of the third quarter-wave plate is substantially 90 degrees, an included angle between an optical axis of the first half-wave plate and an optical axis of the patterned half-wave plate is substantially 90 degrees, and an included angle between an optical axis of the second quarter-wave plate and the optical axis of the third quarter-wave plate is substantially between 55 degrees and 125 degrees.

2. The three-dimensional display apparatus according to claim 1, wherein the three-dimensional display apparatus has a horizontal direction, and an included angle between the polarization direction of the linearly polarized image and the horizontal direction is substantially 45 degrees.

3. The three-dimensional display apparatus according to claim 1, wherein the three-dimensional display apparatus has a horizontal direction, and the polarization direction of the linearly polarized image is substantially parallel or perpendicular to the horizontal direction.

4. The three-dimensional display apparatus according to claim 1, wherein the display panel comprises a panel polarizer, the panel polarizer is disposed between the pixels and the polarized glass, and an included angle between an absorption axis of the panel polarizer and the optical axis of the third quarter-wave plate is substantially 45 degrees.

5. The three-dimensional display apparatus according to claim 4, wherein the linear polarizer has an absorption axis substantially perpendicular to the absorption axis of the panel polarizer.

6. The three-dimensional display apparatus according to claim 1, wherein the patterned half-wave plate have two different regions with different phase-retardation, phase-retardation of one region is substantially λ/2, where λ represents the wavelength, phase-retardation of the other region is substantially zero, and the regions with different phase-retardation are arranged alternately.

7. The three-dimensional display apparatus according to claim 6, wherein the patterned half-wave is fabricated by a heating process, and the region with the substantial λ/2 phase-retardation has a stretch axis, and an included angle between a direction of the heating process and the stretch axis is between 45 degrees and 135 degrees.

8. The three-dimensional display apparatus according to claim 6, wherein the patterned half-wave plate is fabricated by a laser radiation.

9. The three-dimensional display apparatus according to claim 1, wherein the patterned half-wave plate comprises a plurality of strip patterns, each of the plurality of strip patterns respectively corresponding to even rows or odd rows of pixels.

10. The three-dimensional display apparatus according to claim 1, wherein the patterned half-wave plate comprises a plurality of strip patterns, each of the plurality of strip patterns respectively corresponding to even columns or odd columns of pixels.

11. The three-dimensional display apparatus according to claim 2, wherein the three-dimensional display apparatus has a horizontal direction, and an included angle between the optical axis of the second quarter-wave plate and the horizontal direction is substantially between 0 degrees and ±35 degrees.

12. The three-dimensional display apparatus according to claim 11, wherein the included angle between the optical axis of the second quarter-wave plate and the horizontal direction is substantially 25 degrees.

13. The three-dimensional display apparatus according to claim 3, wherein the three-dimensional display apparatus has a horizontal direction, and an included angle between the optical axis of the second quarter-wave plate and the horizontal direction is substantially between 100 degrees and 170 degrees.

14. The three-dimensional display apparatus according to claim 13, wherein the included angle between the optical axis of the second quarter-wave plate and the horizontal direction is substantially 105 degrees.

15. The three-dimensional display apparatus according to claim 1, wherein the first half-wave plate is disposed between the first quarter-wave plate and the display panel.

16. The three-dimensional display apparatus according to claim 1, wherein the first quarter-wave plate is disposed between the first half-wave plate and the display panel.
